(19) United States
(12) Patent Application Publication
(10) Pub. No.: US 2026/0330234 A1
(43) Pub. Date: Oct. 22, 2026

(54) TIME AND PROGRESS ESTIMATES FOR MULTI-AGENT INTERACTIONS

(71) Applicant: GDM Holding LLC, Mountain View, CA (US)

(72) Inventors: Florian Nils Hartmann, Zurich (CH); Duc-Hieu Tran, Zurich (CH)

(21) Appl. No.: 19/185,059

(22) Filed: Apr. 21, 2025

(51) Int. Cl. G06N 3/0895

(52) U.S. Cl. CPC G06N 3/0895

(57) ABSTRACT

A computer-implemented method of using a neural network system configured to process a network input to generate an output sequence comprising a plurality of data items is provided. The method comprises obtaining the network input, and processing the network input using the neural network system to sequentially generate the plurality of data items representing a response to the network input and including one or more prediction data items, each prediction data item specifying a respective prediction of the number of data items that will be located subsequent to said prediction data in the output sequence when the output sequence is complete.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that includes a neural network system that predicts the length of an output sequence that will be generated in response to a query input. The predicted length of the output sequence can be used to provide a user with an estimate of the remaining time until the output sequence is complete or an estimate of the progress of the query. Some implementations train the neural network system.

In a first aspect there is described a computer-implemented method of using a (trained) neural network system configured to process a network input to generate an output sequence comprising a plurality of data items. The network input defines a query or task for the neural network system, and may be obtained from a user (e.g., via user interface), from another software application, or the like. The query input can include one or more modalities including text, image, audio, video, or a combination of one or more modalities. For example, the neural network system can be a vision language model which can process both visual (image and video) data along with text data as the network input. As another example, the neural network system can be an audio neural network, where the query input includes audio data. In general, the network input can include multiple modalities depending on the specific architecture of the neural network system. The plurality of data items may comprise one or more output tokens from a vocabulary of output tokens (e.g., text tokens, tokens representing image data or audio data, and the like).

The method comprises obtaining the network input and sequentially generating the output sequence. The output sequence is generated by processing the network input using the neural network system to sequentially generate the plurality of data items representing a response to the network input and including one or more prediction data items. Each prediction data item specifies a respective prediction of the number of data items that will be located subsequent to said prediction data in the output sequence when the output sequence is complete.

In a second aspect there is described a computer-implemented method of training a neural network system having a plurality of parameters and configured to process a network input to generate an output sequence comprising a plurality of data items. The method comprises obtaining a dataset of training examples. Each training example comprises a training network input, and an associated output sequence comprising a plurality of data items comprising one or more training prediction data items specifying the number of data items located subsequent to said training prediction data in said output sequence. The method further comprises selecting a training example, obtaining the training network input of the training example, processing the training network input using the neural network system to sequentially generate a respective plurality of data items of a respective output sequence representing a response to the training network input and including one or more prediction data items, each prediction data item specifying a respective prediction of the number of data items that will be located subsequent to said prediction data in the output sequence when the output sequence is complete, and updating current values of the neural network system parameters to reduce a discrepancy between the generated output sequence and the output sequence of the training example.

Particular embodiments of the subject matter described in this specification can be implemented so as to realize one or more of the following advantages.

When known neural networks cannot complete a task set by a user (or by a software agent) instantaneously, the user has to wait for the neural network to complete the task without any indication of how long this might take. This is inconvenient to the user. Implementations of the described techniques address this problem. The described techniques can provide to the user/agent an indication of the remaining time until the task will be completed and/or an indication of the progress of the task. Such a functionality makes for a better user experience since it also allows the user to have a better expectation of how long they need to wait for, e.g., they can do other things in the meantime. This is also useful in cases when an agent (e.g., another software application) requests the task since the agent can better manage its resources, e.g., schedule other tasks based on remaining time.

Furthermore, it is also advantageous that the system described in this specification can be combined with standard (vision-) language model architectures. That is, in broad terms, the proposed system enables a neural network having a standard (vision) transformer architecture but improved user experience because of a novel training process that encourages the neural network to learn to generate time/progress estimates.

In certain implementations, a prediction of the remaining time until the generation of the output sequence is completed may be generated based on the one or more prediction data items. Whenever a new prediction data item is generated, the prediction of the remaining time may be updated based on the new prediction data item. The prediction data items may be generated in regular or irregular intervals. As one example, when the output sequence includes a plurality of data items representing an image or an audio waveform, a prediction data item may directly precede the plurality of data items representing the image or the audio waveform in the output sequence. This is useful because the generation of the plurality of data items representing the image or an audio waveform may be time-intensive and thus generating a prediction data item in the directly preceding step enables a timely update of the prediction of the remaining time.

In certain implementations, the neural network system may be in communication with at least one further agent (i.e., an agent other than the agent that in some examples provides the network input). This further agent may be a software agent or a software tool running on the same computer as the neural network system or being in communication with the neural network system via a network (e.g., the Internet). The neural network system may be in communication with the further agent to “integrate” the capabilities of the agent with the neural network system, i.e., the agent provides an extra layer of capability or additional functionality that is not available from the output of the neural network system itself. More specifically, in these cases, the neural network system may also generate a query data item specifying a query for the further agent, i.e., the plurality of data items in the output sequence further may comprise the query data item. The query data item can be used to query the further agent (e.g., to instruct the further agent to perform a task or to retrieve desired information), i.e., the method of using the neural network system may further comprise transmitting a query based on the query data item to the agent, and receiving, from the agent, a response data item for the transmitted query. The neural network system may then generate at least one data item of the output sequence based on the response data (e.g., the neural network system may provide the response data item as one of the data items of the output sequence). In some examples, the agent can include a software application that can communicate through an application programming interface (API) or other interface that allows other software applications to provide inputs to and receive outputs from the software application. For example, calendar applications, web browsers, travel planning applications, and internet of things devices, can all communicate through APIs either over the web, local networks, or via local computational resources. In general, software tools that can communicate through a “request” and “response” scheme with predictable and structured input and output formats can provide additional functionality to language model neural networks.

In certain implementations, the plurality of data items in the output sequence may further comprise a time data item associated with the query data item. The time data item specifies a prediction of a waiting time until the respective response data item will be received from the agent. In other words, the neural network system may estimate how long the agent will take to return a response. This estimate can be used to update the prediction of the remaining time until the neural network system can complete the output sequence. The time data item may be generated when an agent is called, e.g., time data item may be generated in the step preceding the generation of the associated query data item. The time data item may be generated taking the type and complexity of the query into account. Thus, by estimating how long the agent may take to respond, a more accurate time estimate for the output sequence can be generated.

In certain implementations, the neural network system may use the waiting time until the agent responds, e.g., to reprocess the network input with increased processing resources (i.e., the neural network system may have a “deeper think” about the network input), to process queries by other users, to reallocate unused processing resources to other computing jobs, or the like. More specifically, in one possibility, when the predicted wait time exceeds a predefined threshold criterion, the neural network system may further process the network input (during the wait time) to update at least one of the data items that precede the time data item in the output sequence. As one example, during the wait time, the neural network system may generate a plurality of alternative responses to the network input (taking into account that the response from the agent is still outstanding), evaluate the responses according to an evaluation metric and select the response with the highest evaluation to update the data items of the output sequence.

In another possibility, when the predicted wait time exceeds the threshold criterion, the system may reallocate (or distribute) computing resources (CPU, memory, storage, etc.) currently allocated to the neural network system to one or more other processes implemented on the one or more computers implementing the neural network system. The neural network system may select one of the above based on the estimated waiting time. Because the neural network system “knows” how long the wait time will be (or at least has an estimate of the wait time), the neural network system can select the most efficient use of the otherwise unused compute resources while waiting for agent to respond.

That is implementations of the system can perform a first process, i.e., the process of generating a network response described herein, in parallel with one or more second processes. The operation of the first and second processes is interleaved such that the second process is performed whilst the first process is waiting for the agent response.

The second process can be a process that generates respective data items of a further output sequence using the neural network system, e.g., another implementation of the first process. Also or instead an instance of the second process can be a background process, such as a housekeeping process for the neural network system.

As some examples, where the neural network system implements a large language model (LLM) or vision language model (VLM), in particular on a distributed computing system having a plurality of nodes, i.e., computers, such housekeeping processes may include one or more of the following: A dynamic load balancing task to monitor the utilization of computing resources by the modes and to allocate workloads between the nodes during token generation to control utilization to mitigate overloading or bottlenecks. A system health monitoring task to monitor and log performance metrics of the system, e.g., latency or throughput of nodes in the system. A data caching task to cache embeddings or intermediate results of token generation, e.g., generated by a sub-model of the neural network system.

A further example of such a second process is a node maintenance or restart process, e.g., when a node has crashed, or run out of memory, has lost connectivity or has been removed (or added), or has become slow or unresponsive. This type of second process could not otherwise be performed in parallel with the first process without significantly interfering with the sequential generation of the data items (tokens), and it is therefore particularly useful to be able to take advantage of the wait time.

In certain implementations, the agent may respond with its own estimate of how long the received query will take to complete before transmitting the actual response to the query. More specifically, in some cases, the neural network system receives, from the agent, a further prediction of the waiting time until the response data item will be received from the agent and updates the current prediction of the remaining time for completing the output sequence based on the further prediction of the waiting time. In some case, when the time estimate by the agent is significantly longer than the time estimate by the neural network system, the neural network system may cancel the query to the agent and transmit the query to a different agent as described below in more detail.

In certain implementations, the neural network system may be in communication with a plurality of agents. In these cases, the neural network system may select to which agent the query is to be provided based on respective wait time estimates. More specifically, the neural network system may generate, for each agent of the plurality of agents, a respective prediction of a waiting time until a corresponding response data item would be received from that agent for the query specified in the query data item, and select one of the agents based on the determined predictions. The query is then transmitted to the selected agent. A response data item for the transmitted query is then received from the agent, and at least one output data item of the output sequence is generated based on the response data. Thus, the capability of estimating wait times associated with agent responses allows the neural network to select the most appropriate agent for a particular query.

In certain implementations, the neural network may receive a time estimate from the selected agent which is significantly longer than the corresponding time estimate by the neural network system. In these cases, the neural network system may cancel the query to the selected agent and select one of the other agents to receive the query. More specifically, the neural network system may select one of the agents as a candidate agent based on the determined predictions, transmit the query specified in the query data item to the candidate agent, receive, from the candidate agent, a respective prediction of the waiting time until the response data item will be received from the agent, and selecting, as the “selected” agent, one of the other agents based on the received prediction of the waiting time and the determined predictions. Thus, the neural network system ability to predict and process wait time estimates enables flexible reassigning of queries between multiple agents.

In certain implementations, the neural network system may comprise a “large” neural network and a “small” neural network. The large neural network has more learnable parameters than the small neural network (often the large neural network has also a more complex architecture). In these cases, the small neural network may be used configured to process the network input to generate the one or more prediction data items while the large neural network generates the other data items of the output sequence. This can be advantageous to add the capability of generating time/progress estimates to large models without having to re-train the large model.

In certain implementations, the neural network system may be trained using a training dataset that comprises a training tuple comprising a training network input, and an associated output sequence comprising a plurality of data items including one or more prediction data items, a query data item specifying a query for an agent, and a time data item associated with the query data item, the time data item specifying a waiting time until respective response data item have been received from the agent in response to transmitting the query specified in the query data item to the agent. The neural network system may then be trained to predict the associated output sequence for the training network input. To this end, the method may comprise sequentially generating an output sequence for the training network input of the further training example using the neural network system and updating current values of the neural network system parameters to reduce a discrepancy between the generated output sequence and the output sequence of the further training example.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example computer system that processes a network input to generate an output sequence.

FIG. 2 is a flow diagram of an example process for processing a network input to generate an output sequence.

FIG. 3 shows a variation of the example computer system of FIG. 1.

FIG. 4 is a flow diagram of an example process for training a neural network system.

Like reference numbers and designations in the various drawings indicate like elements.

### DETAILED DESCRIPTION

Neural networks such as large language models (LLMs) are increasingly being used to power AI agents and personal AI assistants. However, not all tasks that users want their AI agents/assistants to perform can be completed instantly. As one example, obtaining responses from external agents (or tools) can take time, e.g., an input prompt of “Show me some flight options for a 1 week trip to Bangkok” could lead to calls to specialized flight booking agents or flight search engine tools, which need some time to generate a response. Similarly, querying other personal AI assistants may not result in immediate responses, e.g., a response to an input prompt of “Can you schedule a meeting with Tom for tomorrow afternoon?” may be delayed when Tom's AI assistant is not immediately reachable or when Tom's AI assistant waits for Tom's input before responding. As another example, the task set by the user may include steps which are computationally too expensive steps to be performed instantaneously, e.g., in response to an input prompt “Turn this draft of a screenplay into a 15-minute video” the neural network may start rendering such a video itself or call other specialized agents and tools to do so, either way the rendering of the video will normally need some time to be completed.

While traditional software applications that are not based on machine learning models sometimes offer some form of time and progress estimates (e.g., when copying files around), known AI agents/assistants do not provide such detailed time and progress estimates. For example, known AI agents/assistants are often based on a single LLM model outputting text which can then be streamed. Thus, when the generation of the content is delayed, as described above, the user needs to wait without knowing how it will take. This is inconvenient to the user. Further, when the AI agent/assistant waits for an external agent to respond to a query, computing resources are not efficiently being used because the AI agent/assistant is idling, i.e., not performing any useful computations (often even blocking computing resources from being used by other processes). Embodiments described in the specification overcome at least some of the above-described problems.

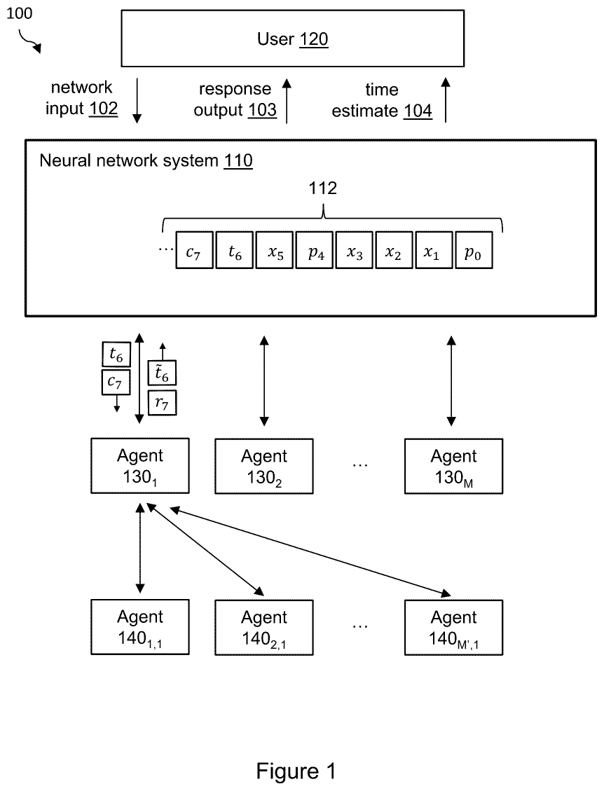

FIG. 1 shows a system 100 implemented as computer programs on one or more computers in one or more locations, for using a neural network system to process a network input.

The system 100 comprises a neural network system 110 that is in communication with a user 120 (e.g., via a user interface) and a plurality of agents 130₁-130_{M}. Each one the agents 130₁-130_{M} can be in communication with further agents. As illustrated in FIG. 1, the agent 130₁ is in communication with a plurality of agents 130_{M′,1}-130_{M′,1}.

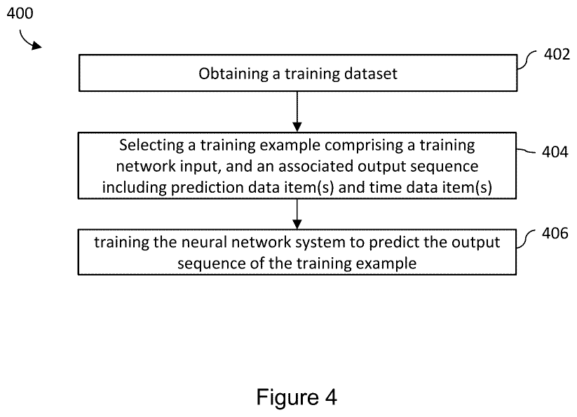

The neural network system 110 has a plurality of (trainable) parameters. The neural network system 110 may be trained (e.g., in a self-supervised manner) using a training dataset that includes a set of pairs each comprising a network input and a corresponding output sequence. An example process of training the neural network system 110 is described in detail below with reference to FIG. 4.

In general, the neural network system 110 may have any appropriate neural network architecture including, e.g., one or more feedforward or convolutional neural network layers, or a transformer neural network subsystem, i.e., a neural network subsystem including one or more transformer blocks or self-attention layers. A transformer block typically includes an attention or self-attention neural network layer followed by a feedforward neural network. An attention, or self-attention, neural network layer is a neural network layer that includes an attention or self-attention mechanism that operates over an attention layer input to generate an attention layer output.

As an example, the neural network system 110 may comprise a Transformer neural network (a network with an architecture similar to the Transformer neural network described in Vaswani, et al., Advances in neural information processing systems, 30, 2017). For example, the neural network system 110 may comprise an architecture similar to a (standard) vision transformer neural network (e.g., similar to the Vision Transformer (ViT) described in Dosovitskiy, et al., arXiv:2010.11929). In general, a Transformer neural network can be characterized by having a succession of attention, e.g., self-attention, neural network layers. Each attention neural network layer has an attention layer input for each element of the input and is configured to apply an attention mechanism over the attention layer input to generate an attention layer output for each element of the input. In implementations the attention mechanism computes a similarity between a query and a set of key-value pairs. In implementations one or both (in the case of self-attention) of the query and the set of key-value pairs are determined from the attention layer input.

As an example, in a self-attention neural network layer an input embedding may be used to determine a query vector and a set of key-value vector pairs, that are used to generate an updated embedding comprising a weighted sum of the values, weighted by a similarity function of the query to each respective key. The similarity function may comprise, e.g., a dot product, cosine similarity, or other similarity measure; the query, keys, and values may all be vectors. For example the attention mechanism may be configured to apply each of a query transformation, e.g., defined by a matrix W^{Q}, a key transformation, e.g., defined by a matrix W^{K}, and a value transformation, e.g., defined by a matrix W^{V}, to the attention layer input for each element of an input sequence X to derive a respective query vector Q=XW^{Q}, key vector K=XW^{K}, and value vector V=XW^{V} which are used determine an attended sequence for the output.

After training the neural network system can be used to process a query from the user 120. That is the neural network system 110 is configured to receive from the user 120 a network input 102, to process the network input 102, and to provide to the user a response output 103 and a time estimate 104. The user 120 can be in communication with the neural network system 110 directly via a user interface of the one or more computers that implement the neural network system 110 or via a network (e.g., the Internet) using another computing device.

In broad terms, the network input 102 (also referred to as input “prompt”) specifies instructions and/or a query for the neural network system 110 to achieve a desired outcome (e.g., perform a specified task). The network input 102 can be provided as a text input. This text input may define a sequence of text tokens from a vocabulary of text tokens. The text tokens can each represent, e.g., words, wordpieces or characters in a natural or computer language.

The response output 103 represents the response of the neural network system 110 to the network input 102. For example, the response output 103 can indicate that a task has been completed, an answer to a query, and the like. In general, the response output 103 can include a sequence of tokens representing text, image, video, audio data, and the like. The complete response output 103 may not be immediately available because the generation of the response output 103 takes some time. In these cases, portions of the response output 103 may be provided (e.g., displayed) to the user 120 as they become available, or the response output 103 may only be provided to the user 120 once the generation of the response output 103 has been completed. In general, the time required for the neural network system 110 to complete the response output 103 depends on the details of the specific network input 102 (e.g., the complexity of the query/task) and, in some applications, also on external factors, such as response times of the external agents 130₁-130_{M} as further described below.

The time estimate 104 is an estimate (or prediction) by the neural network system 110 of the remaining time until the complete response output 103 is ready (the time estimate 104 may specify the remaining time in any suitable unit of time, e.g., seconds). The time estimate 104 can be displayed to the user on a display (e.g., as a countdown timer). The time estimate 104 is provided to the user 120 before the generation of the response output 103 is completed. As described below in more detail, a first “guess” of the time estimate 104 can be generated before generation of the response output 103 starts (or shortly after), and can be updated throughout the generation of the response output 103.

As noted above, the neural network system 110 is configured to generate the response output 103 and the time estimate 104 by processing the network input 102. More specifically, the neural network system 110 is configured to sequentially generate an output sequence 112 of data items (“tokens” hereafter), and to generate the response output 103 and the time estimate 104 based on the tokens of the output sequence 112.

In general, the neural network system 110 can generate (or “decode”) different “types” of tokens. This includes “regular” tokens, denoted xᵢ (where the index “i” indicates the position of the token in the output sequence 112; e.g., x₁, x₂, x₃ and x₅ in FIG. 1), that are used to generate the response output 103. The regular tokens can include one or more text tokens, and/or one or more tokens representing image data or audio data.

The neural network system 110 can also generate “special” RemainingTokensEstimate (RTE) tokens (“prediction data items”), denoted pᵢ. Each RTE token specifies how many tokens the neural network system 110 predicts are still to be decoded until the EndOfSequence (EOS) token (i.e., until the output sequence 112 is completed) (the RTE tokens are a “special” type of tokens in that known neural network systems do not generate RTE tokens). The RTE tokens are used to generate and update the time estimate 104, i.e., whenever a “fresh” RTE token is generated, the time estimate 104 may be updated based on the new RTE token. In some implementations, the time estimate 104 may be computed based on a RTE token and a (current) decoding speed (e.g., expressed in token per second), e.g., as the product of the number of remaining token and the decoding speed. As described below in more detail, in some implementations, the time estimate 104 may be computed also based on an estimate of how long a tool or API call will take to complete (e.g., the remaining decoding time and the tool or API call time may be added to compute the time estimate 104).

The neural network system 110 may be configured to generate a RTE token p₀ as the first token of the output sequence 112 (as illustrated in FIG. 1). Alternatively, neural network system 110 may generate the first RTE token after a short chain of thought (e.g., after having decoded a few regular tokens) which in some case can provide a better estimate of the number of remaining tokens. The neural network system 110 may be configured to generate further RTE tokens (e.g., p₄ in FIG. 1) at regular (e.g., every X tokens where X is an integer) or irregular intervals. For example, in some implementations, the neural network system has been trained to learn output a new RTE token whenever this would meaningfully change (improves) the time estimate 104, i.e., at natural break points, e.g., at steps in a chain of reasoning (thought) or when starting to generate an image or audio data.

The external agents 130₁-130_{M} are software applications that are in communication with the neural network system 110. The external agents 130₁-130_{M} can include AI-based software agents/assistants and conventional software tools (e.g., search engines, calendar applications, web browsers, travel planning applications, internet of things devices, machine translation applications and the like). Each agent 130 provides an application programming interface (API) or other interface that allows other software applications (e.g., the neural network system 110) to provide inputs to and receive outputs from the agent. In general, the agents 130₁-130_{M} can communicate through a “request” and “response” scheme with predictable and structured input and output formats can provide additional functionality to the neural network system 110. The neural network system 110 can provide the input to a selected agent through the API (or local software command, or any other method of communicating with the agent), obtain an output from the particular agent, and process the output from the agent to generate further tokens of the output sequence. As described further below, the neural network system 110 can be trained to decide which agent to call, when to call it, what arguments to pass, and how to best incorporate the results into future token prediction.

To call one of the agents 130, the neural network system 110 generates a “special” query token (“query data item”), denoted cᵢ specifying a query (i.e., a request for information, instruction for performing a task, and the like; e.g., c₇ in FIG. 1) for the agent. The query token cᵢ may also include information identifying the target agent (e.g., the query token cᵢ may specify a tuple including an API call and the query).

The neural network system 110 is configured to provide the query specified in a query data item to the corresponding agent. In response to receiving the query, the agent processes the query and generates a corresponding response token (“response data item”) denoted cᵢ, e.g., c₇ in FIG. 1. In some cases, to process the query, the agent may decide to call other agents which in turn may call further agents, and so on.

The neural network system 110 is configured to process a received response token to generate a token of the output sequence. For example, the received response token may simply be integrated into the output sequence 112 such that the response token can be used to generate the response output 103.

The neural network system 110 is also configured to generate a “special” AgentWaitingTimeEstimate (AWTE) token (“time data item”), denoted tᵢ, e.g., t₆ in FIG. 1. Each AWTE token is associated with a query token. More specifically, a AWTE token specifies a prediction of a waiting time until a response token will be received from the agent indicated in the associated query token (i.e., how long the agent will take to answer the query).

The AWTE tokens can be used to update the time estimate 104. That is when a AWTE token is generated, the time estimate 104 may be generated based on the AWTE token and the last RTE token (e.g., by adding the respective time estimates for the AWTE token and the RTE token), i.e., the system aggregates the different “delays” to provide an accurate time estimate 104 to the user. In some cases, the predicted wait time specified by the AWTE token may be quantitative (e.g., measured in seconds). In other cases, the predicted wait time specified by the AWTE token may be qualitative, e.g., as a natural language description that the output is blocked by a different user (i.e., not the user 120), e.g., “Waiting for Tom to weigh in on the calendar event”. In these cases, the time estimate 104 may be generated based on the AWTE token and the last RTE token by appending the qualitative estimate to the quantitative estimate (“5 minutes remaining, plus however long Tom takes to look at the request”) or by keeping only the qualitative estimate (“Waiting for Tom to look at the request”).

In some implementations, one or more of the agents 130 are configured to, in response to receiving a query, provide a time estimate, denoted t~i, indicating how long the agent expects answering the query to take, e.g., t~6 in FIG. 1. Thus, in this case, similar to the neural network system 100, the agents provide time estimates to the “caller” before the task is completed. The agents 130 can use static code to produce the time estimates (e.g., a search engine can generate a time estimate based on the size of the search index).

The neural network system 110 may be further configured to process the time estimate t~i from the agent to update the time estimate 104. For example, when a time estimate t~i received, the time estimate 104 may be generated based on the time estimate t~i and the last RTE token (i.e., in this case, the corresponding AWTE token is not used because the time estimate by the agent is assumed to be more accurate than the corresponding time estimate by the neural network system 110).

In some implementations, the neural network system 110 has to select between multiple agents 130 which are suitable for answering a certain query. In these cases, the neural network system 110 may determine, for each suitable agent, a respective prediction of a waiting time until a corresponding response token would be received from the agent in response to transmitting the query. The neural network system 110 may then select one of the agents based on the determined predictions (e.g., the agent with the shortest predicted wait time) and provides the query to the selected agent. In these cases, when the agent responds with its own time estimate, and the neural network system 110 determines that the agent's time estimate is significantly longer than the time estimate by the neural network system 110, the neural network system 110 may cancel the query sent to the selected agent, select another one of the suitable agents (e.g., the agent with the next shortest predicted wait time), and provides the query to the newly selected agent. Thus, the capability of generating and processing time estimates enables the neural network system 110 to flexibly cancel and re-direct queries to external agents in order to reduce the overall time for completing the output sequence 112.

Because the neural network system 110 “knows” how long it will take to receive a response from an agent (either from its own estimates, i.e., ATWE token, or from the received estimates by the external agents), the wait time can efficiently be used. For example, during a wait time, the neural network system 110 may process a network input from another user. Alternatively, for the duration of the wait time, the neural network system 110 may free up compute resources which are allocated to the neural network system 110 (processing resources, memory, storage, etc.) allowing other applications running on the one or more computers implementing the neural network system 110 to benefit from the freed up resources. The efficiency of this reallocation of compute resources is increased by the knowledge of how long the wait time is likely to be.

While the neural network system 110 of FIG. 1 has been described as receiving input from the user 120, it is to be understood that in other implementations, the neural network system may receive the network input from an agent (which may receive its input from a user or another agent).

While the neural network system 110 of FIG. 1 has been described as providing the time estimate 104 to the user, it is to be understood that in other implementations, the neural network system may alternatively or additionally provide a corresponding progress estimate to the user (i.e., a prediction of the progress of the task/query associated with the network input 102). For example, the prediction of the progress may be generated based on A/(A+B), where A denotes the time passed since the network input has been received and B denotes the estimated remaining time. The progress may be visualized (on a display) as a progress bar.

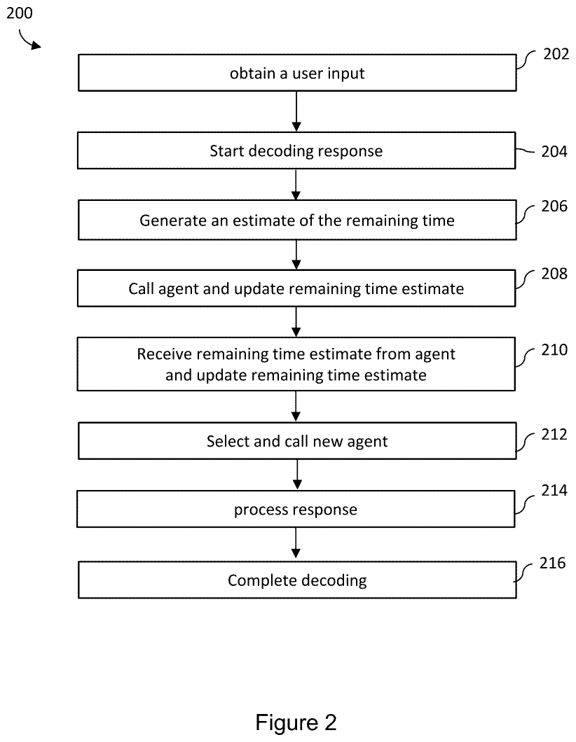

FIG. 2 is a flow diagram of an example process 200 of using a neural network system configured to process a network input to generate an output sequence comprising a plurality of tokens (“data items”). The process 200 of FIG. 2 may be implemented by one or more computers in one or more locations; for convenience the process is described with reference to FIG. 1.

At an initial step 202, a network input 102 (defining a query) is obtained from the user 120 (e.g., via a user interface). The process 200 involves using the neural network system 110 to process the network input 102 to sequentially generate the tokens of the output sequence 112 (“to sequentially generate” means that the tokens are generated one after the other rather than in parallel). At step 204, the neural network system 110 starts decoding the output sequence, i.e., starts generating tokens of the output sequence 112. At step 206, a first RTE token of the output sequence is generated. This first RTE token can be the first token of the output sequence or can be generated after a short chain of thought, e.g., the neural network system 110 may initially decode a few regular token (e.g., in range of 5 to 100) before generating the first RTE token. The first RTE token is then used to generate the time estimate 104 which is displayed to the user 120. Then the neural network system 110 continues decoding the output sequence.

At step 208, the neural network system 110 “decides” to call an external agent (e.g., agent 1301). To this end, the neural network system 110 decodes a corresponding query token (specifying the query for the external agent) and a AWTE token (specifying a predicted wait time associated with the query for the agent). The query is then provided to the external agent and the time estimate 104 is updated based on the AWTE token and the last RTE token.

At step 210, the external agent 1301 provides, to the neural network system 110, a time estimate indicating how long the agent expects answering the query to take. In response to receiving the time estimate, the time estimate 104 is updated.

At step 212, it is also determined that the time estimate by the external agent 1301 is significantly longer than the neural network system 110 expected. In response, the neural network system 110 cancels the query to the external agent 1301 and selects another suitable external agent for the query. The time estimate 104 is updated based on the predicted wait time for the newly selected agent.

At step 214, a response token is received from the newly selected agent. The response token is processed by the neural network system 110, e.g., integrated into the output sequence 112. In some cases, a previously generated regular token of the output sequence 112 may be updated based on the response token. The decoding process then continues with the neural network system 110 continuing to generate regular, RTE, query and AWTE tokens as described above until the output sequence 112 is completed.

At step 216, the output sequence 112 is completed. The response output 103 is generated based on the output sequence 112, e.g., based on the regular tokens of the output sequence 112 and response tokens that have been integrated into the output sequence 112.

In some implementations of the process 200, a progress estimate is generated and displayed to the user 120 in addition or as an alternative to the times estimate 104.

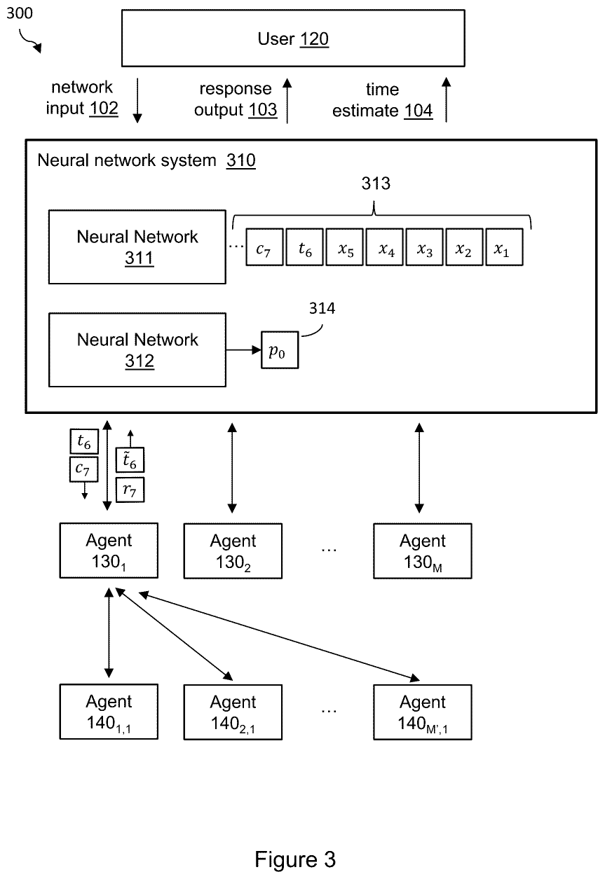

FIG. 3 illustrates a variation of the system 100 of FIG. 1. The system 300 of FIG. 3 is identical to the system 100 of FIG. 1 except that the neural network system 310 comprises a first neural network 311 and a second neural network 312.

The first neural network 311 is configured to process the network input 102 to sequentially generate a sequence 313 of tokens. More specifically, the first neural network 311 is configured to decode regular, query, and AWTE tokens as described above with reference to FIG. 1. The second neural network 312 is configured to process the neural network input 102 to generate a RTE token 314. Thus, the second neural network can be considered to be a dedicated model for generating RTE tokens. The second neural network 312 can be smaller in terms of number of learnable parameters and simpler in terms of network architecture than the first neural network. The sequence 313 and the RTE token 314 jointly form the output sequence of the neural network system 310.

An example process of training the neural network system of FIGS. 1 and 3 will now be described with reference to FIG. 4. The process 400 of FIG. 4 trains the neural network system to predict the time (or number of remaining tokens) ahead of decoding the full sequence. In general, the neural network system can be trained to learn to decode output sequences that include regular, RTE, query, and AWTE tokens by using a training dataset that includes training examples that each comprise a network input and an associated output sequence that including regular, RTE, query, and AWTE tokens. The neural network system is then trained to predict the output sequence given the training network input using self-supervised learning. In some implementations, the neural network system may be pre-trained (the neural network system may be a pre-trained foundational model) and the process 400 of FIG. 4 is used to fine-tune the neural network system.

More specifically, at step 402 the training dataset is obtained. Such a training dataset can be obtained in many ways, e.g., by observing how long a known AI agent takes to generate a response, either in live usage or on proxy data. To generate the training data set, RTE and AWTE tokens and time estimates are then added (based on the observed timings) to an instruction tuning dataset comprising training examples that each comprise a network input and an associated output sequence. At step 404, a training example is selected, and the neural network system is used to generate an output sequence for the training network input of the training example (as described above with reference to FIGS. 1 to 3). At step 406, the neural network system is then trained (i.e., the parameters of the neural network system are updated/adjusted) to output the token of the output sequence of the training example and the correct estimates. The updates of parameters of the neural network system are computed using known optimisation methods (e.g., gradient descent methods). The parameters of the neural network system may be adjusted based on a loss that takes into account the concrete numbers behind the estimates, rather than the actual tokens (e.g., an estimate of “100 tokens” compared to a ground truth of “900 tokens” may have a higher loss than an estimate of “899 tokens”, even though the former is closer in terms of token overlap (i.e., character difference)).

In some implementations, when the neural network system is not able to make a good initial estimate, the neural network system can be encouraged to generate estimates multiple times during the inference. For example, the neural network system can be encouraged to generate estimates at a plurality of points uniformly across the output sequence. Alternatively, it can be checked how well the neural network system can predict the estimates at the different times, and the neural network system can then be trained to output a new time estimate whenever the time estimate meaningfully changes (improves).

In general an agent as described herein can be any software tool that includes an interface such as an API, e.g., a search agent for searching the web, an online shopping agent, a, recommendation agent, a generative agent, e.g., to generate an image or video or computer code with content or to perform a function characterized by the query sent to the agent, and so forth. Some further examples of agents are given below.

The agent(s) described herein can include one or more image processing agents, e.g., agents that are specialized to processing a particular, or different particular types of images. Some examples can be images of the natural environment or of particular types of natural environment, images of urban scenes or types of urban scene, astronomical images, medical images or particular types of medical image, and so forth. The query can define an image processing task performed on pixels of a still or moving image; and the response data item for the transmitted query can define a result of the image processing task. The image processing task can be, e.g., an image classification task in which pixels of a still or moving image are processed to generate a response that categorizes a content of the image; or an object detection task in which the image is processed to generate a response that locates coordinates, e.g., bounding box coordinates, of one or more objects or types of object in the image; or an instance detection task in which the image is processed to generate a response that identifies the shapes of one or more objects or types of object in the image.

The agents can include one or more materials design agents for designing a physical material. Some examples include a protein design agent (e.g., an AlphaFold-related agent), a retrosynthesis agent (such as described in WO 2021/263238), or a materials design agent (such as described in Yang, et al., “Generative Hierarchical Materials Search”, arXiv:2409.06762, 2024). The query can define a materials design task performed, e.g., specifying one or more desired characteristics of the material; and the response data item for the transmitted query can define a result of the materials design task. Afterwards the material can be physically made (synthesized), e.g., for testing.

The agents can include one or more robot control agents for controlling a mechanical robot to perform a physical task. The query can define a physical task to be performed by the robot; the response data item for the transmitted query can define a result of the physical task, e.g., it may include one or more observations of a result of the task, i.e., observations captured from the real world that have been returned as an output from the agent and that characterize a result of the physical task (which may be a synthesized material in the case of the preceding example).

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method of using a neural network system configured to process a network input to generate an output sequence comprising a plurality of data items, the method comprising:
obtaining the network input; and
processing the network input using the neural network system to sequentially generate the plurality of data items representing a response to the network input and including one or more prediction data items, each prediction data item specifying a respective prediction of the number of data items that will be located subsequent to said prediction data in the output sequence when the output sequence is complete.

2. The computer-implemented method of claim 1 further comprising:
generating a prediction of the remaining time until the generation of the output sequence is completed based on the one or more prediction data items.

3. The computer-implemented method of claim 2 further comprising:
conditional on the generation of a prediction data item, updating the prediction of the remaining time based on the most recently generated prediction data item.

4. The computer-implemented method of claim 1, wherein the first data item in the output sequence is one of the one or more prediction data items.

5. The computer-implemented method of claim 1, wherein the output sequence includes a plurality of prediction data items generated at regular intervals.

6. The computer-implemented method of claim 1, wherein the output sequence includes a plurality of prediction data items and a plurality of data items representing an image or an audio waveform, and, and at least one prediction data item directly precedes the plurality of data items representing the image or the audio waveform in the output sequence.

7. The computer-implemented method of claim 1, wherein the neural network system is in communication with at least one agent, and wherein the plurality of data items in the output sequence further comprises a query data item specifying a query for the agent, and wherein the method further comprises:
transmitting a query based on the query data item to the agent;
receiving, from the agent, a response data item for the transmitted query, and
generating at least one data item of the output sequence based on the response data.

8. The computer-implemented method of claim 7, wherein the plurality of data items in the output sequence further comprises a time data item associated with the query data item, the time data item specifying a prediction of a waiting time until the respective response data item will be received from the agent.

9. The computer-implemented method of claim 8 further comprising:
determining whether the predicted wait time exceeds a threshold criterion;
conditional on determining that the predicted wait time exceeds a threshold criterion, further processing the network input, during the wait time and using the neural network system, to update at least one of the data items that precede the time data item in the output sequence.

10. The computer-implemented method of claim 8 further comprising:
determining whether the predicted wait time exceeds a threshold criterion;
conditional on determining that the predicted wait time exceeds a threshold criterion, reallocating compute resources currently allocated to the neural network system to a different process implemented on one or more computers implementing the neural network system.

11. The computer-implemented method of claim 8 further comprising:
determining whether the predicted wait time exceeds a threshold criterion;
conditional on determining that the predicted wait time exceeds a threshold criterion,
obtaining a further network input; and
sequentially generating, during the wait time and for the further network input, respective data items of a further output sequence using the neural network system.

12. The computer-implemented method of claim 8 further comprising:
generating, based on the prediction data item and on the one or more time data items, a prediction of the remaining time until the generation of the output sequence will be completed.

13. The computer-implemented method of claim 8 further comprising:
conditional on the generation of one of the one or more prediction data items or the time data item, updating the prediction of the remaining time based on the most recently generated prediction data item or on the generated time data item.

14. The computer-implemented method of claim 8, further comprising:
receiving, from the agent, a further prediction of the waiting time until the response data item will be received from the agent, and
updating the prediction of the remaining time based on the further prediction of the waiting time.

15. The computer-implemented method of claim 1, wherein the neural network system is in communication with a plurality of agents, and wherein the plurality of data items in the output sequence further comprises a query data item specifying a query, and wherein the method further comprises:
determining, for each agent of the plurality of agents, a respective prediction of a waiting time until a corresponding response data item would be received from the agent in response to transmitting the query specified in the query data item to the agent,
selecting one of the agents based on the determined predictions;
transmitting the query specified in the query data item to the selected agent;
receiving, from the selected agent, a response data item for the transmitted query, and
generating at least one output data item of the output sequence based on the response data.

16. The computer-implemented method of claim 15, wherein selecting one of the agents based on the determined predictions comprises:
selecting one of the agents as a candidate agent based on the determined predictions;
transmitting the query specified in the query data item to the candidate agent;
receiving, from the candidate agent, a respective prediction of the waiting time until the response data item will be received from the agent, and
selecting, as the selected agent, one of the other agents based on the received prediction of the waiting time and the determined predictions.

17. The computer-implemented method of claim 1, wherein the neural network system comprises a first neural network configured to process the network input to generate a first subset of the plurality of data items, and a second neural network configured to process the network input to generate a second subset of the plurality of data items which comprises the one or more prediction data items.

18. The computer-implemented method of claim 17, wherein the first neural network has a larger number of parameters than the second neural network.

19. The computer-implemented method of claim 1, wherein the network input specifies a query based on user input provided at a user interface.

20. The computer-implemented method of claim 2 further comprising:
displaying, to the user, the prediction of the remaining time.

21. The computer-implemented method of claim 1 comprising:
generating a current progress prediction on the one or more prediction data items, and
displaying, to the user, the current progress prediction.

22. The computer-implemented method of claim 1, wherein the neural network system is in communication with an agent, and the network input specifies a query received from the agent.

23. The computer-implemented method of claim 1, wherein the plurality of data items comprises one or more output tokens from a vocabulary of output tokens.

24. The computer-implemented method of claim 23, wherein the one or more output token comprises one or more text tokens.

25. The computer-implemented method of claim 23, wherein the one or more output token comprises one or more tokens representing image data or audio data.

26. The computer-implemented method of claim 1, wherein the neural network system comprises a generative neural network.

27. A computer-implemented method of training a neural network system having a plurality of parameters and configured to process a network input to generate an output sequence comprising a plurality of data items,
the method comprising:
obtaining a dataset of training examples, each training example comprising a training network input, and an associated output sequence comprising a plurality of data items comprising one or more training prediction data items specifying the number of data items located subsequent to said training prediction data in said output sequence;
selecting a training example;
obtaining the training network input of the training example;
processing the training network input using the neural network system to sequentially generating a respective plurality of data items of a respective output sequence representing a response to the training network input and including one or more prediction data items, each prediction data item specifying a respective prediction of the number of data items that will be located subsequent to said prediction data in the output sequence when the output sequence is complete; and
updating current values of the neural network system parameters to reduce a discrepancy between the generated output sequence and the output sequence of the training example.

28. The computer-implemented method of claim 27, wherein the dataset comprises a further training example that comprises a training network input, and an associated output sequence comprising a plurality of data items including one or more prediction data items, a query data item specifying a query for an agent, and a time data item associated with the query data item, the time data item specifying a waiting time until respective response data item have been received from the agent in response to transmitting the query specified in the query data item to the agent,
the method further comprising:
sequentially generating an output sequence for the training network input of the further training example using the neural network system; and
updating current values of the neural network system parameters to reduce a discrepancy between the generated output sequence and the output sequence of the further training example.

29. A system comprising:
one or more computers; and
one or more storage devices communicatively coupled to the one or more computers, wherein the one or more storage devices store instructions that, when executed by the one or more computers, cause the one or more computers to perform operations for using a neural network system configured to process a network input to generate an output sequence comprising a plurality of data items, the operations comprising:
obtaining the network input; and
processing the network input using the neural network system to sequentially generate the plurality of data items representing a response to the network input and including one or more prediction data items, each prediction data item specifying a respective prediction of the number of data items that will be located subsequent to said prediction data in the output sequence when the output sequence is complete.
